(19) United States
(12) Patent Application Publication
(10) Pub. No.: US 2007/0239288 A1
(43) Pub. Date: Oct. 11, 2007

(54) POWER SYSTEM AND WORK FLOW THEREOF

(75) Inventors: Ping Liu, Shenzhen (CN); Li-Ping Chen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,232

(22) Filed: Jul. 14, 2006

(30) Foreign Application Priority Data
Apr. 7, 2006 (CN) 200610060232.1

(51) Int. Cl. G05B 11/01

(52) U.S. Cl. 700/22

(57) ABSTRACT

A power system is provided to include a powerbox having a first storing module and a second programmable storing module for storing program segments. The program segments is for setting the on/off schedule of the powerbox. The first storing module and the second storing module are connected to each other. An input device is connected to the powerbox for input of commands thereto. The first storing module stores a program for identifying and executing the commands and running the program segments in the second storing module according to the commands. A display device is connected to the powerbox for showing results of executing the commands. A work flow of the power system is provided for controlling a powerbox to be powered on or off alternately, includes receiving a command via the input device, determining type of the command, and executing the commands according to the content thereof.

### FIELD OF THE INVENTION

The present invention relates to power systems and work flows of the power systems, more particularly to a programmable power system and work flow of the power system.

### DESCRIPTION OF RELATED ART

After a computer is produced, quality tests are required. One of the tests is for management of a power supply of the computer. In testing, the computer is powered on and off alternately, for testing the function of a power supply of the computer, that is, for testing whether the computer can be started up normally after a power off. Because a great number of computers need to be tested, a powerbox is generally used to control the computers to power on and power off. The powerbox operates according to received commands.

However, the commands input to the conventional powerbox only control the computers to be powered on and powered off one time. If the computers being tested aren't able to startup, another command must be input to the powerbox for controlling the computer to power on and power off again. It is not efficient to input the commands repeatedly.

What is needed, therefore, is a power system that automatically controls the computers to be powered on and off repeatedly.

### SUMMARY OF THE INVENTION

A power system is provided to include a powerbox having a first storing module and a second programmable storing module for storing program segments. The program segments is for setting the on/off schedule of the powerbox. The first storing module and the second storing module are connected to each other. An input device is connected to the powerbox for input of commands thereto. The first storing module stores a program for identifying and executing the commands and running the program segments in the second storing module according to the commands. A display device is connected to the powerbox for showing results of executing the commands. A work flow of the power system is provided for controlling a powerbox to be powered on or off alternately, includes receiving a command via the input device, determining type of the command, and executing the commands according to the content thereof.

Other advantages and novel features will be drawn from the following detailed description of preferred embodiments with attached drawings, in which:

### BRIEF DESCRIPTION OF THE DRAWINGS

FIG. 1 is a block diagram of a power system in accordance with a preferred embodiment of the present invention;

FIG. 2 is a flow chart showing main work flow of the power system in accordance with a preferred embodiment of the present invention; and

FIG. 3 is a detailed flow chart of FIG. 2.

### DETAILED DESCRIPTION OF THE INVENTION

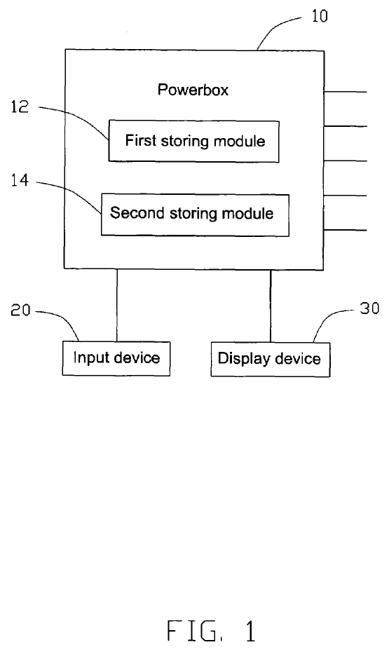

Referring to FIG. 1, a power system in accordance with a preferred embodiment of the present invention, includes a programmable powerbox 10, an input device 20 and a display device 30 respectively connected to the powerbox 10. The powerbox 10 includes a first storing module 12, such as a single chip, and a second storing module 14. The input device 20 is used to input commands, and the display device 30 is used for displaying results of executing the orders. A program is stored in the first storing module 12, for identifying the commands input to the powerbox 10 and executing the commands. The second storing module 14 is used for storing a plurality of program segments input from the input device 20. The plurality of program segments is for setting the on/off schedule of the powerbox 10. The program in the first storing module 12 also identifies and executes the program segments in the second storing module 14. The second storing module 14 has a non-volatile memory thereby ensuring the program segments are maintained in the second storing module 14 even through the powerbox 10 is cut off, for a next running.

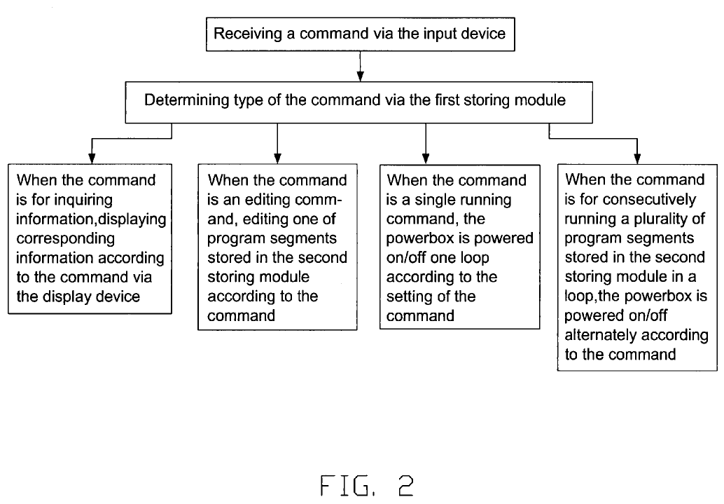

Referring also to FIG. 2, the work flow of the power system comprises following main steps: receiving a command via the input device 20; determining type of the command via the first storing module 12, when the command is a command of inquiring information, displaying corresponding information according to the inquiring command via the display device 30; when the command is an editing command, editing one of program segments stored in the second storing module 14 according to the command; when the command is a single running command, the powerbox is powered on/off one loop according to the setting of the single running command; when the command is for consecutively running a plurality of program segments stored in the second storing module 14 in a loop, the powerbox is powered on/off alternately according to the content of the program segments. The detailed steps of determining type of the command can be executed according to a serial order or a parallel order.

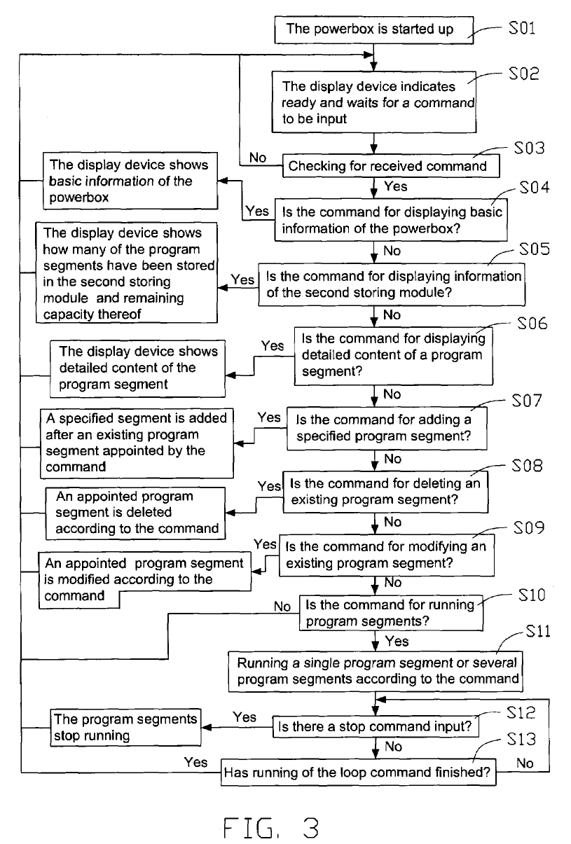

Referring also to FIG. 3, the detailed work flow of the power system according to one embodiment in which the determining step is in a serial order is described as follows:

Step 01: The programmable powerbox 10 is started up;

Step 02: The display device 30 indicates ready and waits for a command to be input;

Step 03: Checking for received command. If no, the process returns to step 02. If yes, the process goes to step 04.

Step 04: Is the command for displaying basic information of the powerbox 10? If yes, the display device 30 shows basic information of the powerbox 10, such as type of the powerbox 10 and name of manufacturer, and so on. Then, the process returns to step 02. If no, the process goes to step 05.

Step 05: Is the command for displaying information of the second storing module 14? If yes, the display device 30 shows how many of the program segments have been stored in the second storing module 14 and remaining capacity of the second storing module 14, and then the process returns to step 02. For example, if “QA0000000000EQ” is input, which is a display information of the second storing module 14 command, the display device 30 then shows “QA0604”. 06 indicates that 6 program segments have been stored in the second storing module 14, and 04 indicates 4 more program segments can be stored. The capacity occupied by the total program segments is not more than the memory of the second storing module 14. If no, the process goes to step 06.

Step 06: Is the command for displaying detailed content of a program segment? If yes, the display device 30 shows detailed content of the program segment, and then the process returns to step S02. For example, “QP0500000000EQ” is input, which is command for displaying detailed content of the fifth program segment. The display device 30 shows “QP0500020003”, 0002 indicating that the powerbox 10 will be powered off after 2 seconds, and 0003 indicating the powerbox 10 will then be powered on 3 seconds after that. If no, the process goes to step 07.

Step 07: Is the command for adding a specified program segment? If yes, a specified program segment is added after an existing program segment appointed by the command, and then the process returns to step 02. For example, if “EA0000020002EQ” is input, the display device 30 shows “EA00”, indicating that a first program segment is added. The first program segment means the powerbox 10 will be powered off after 2 seconds, and be powered on again 2 seconds later. Then, another command is input, “EA0100020002EQ”. The display device 30 shows “EA01”, 01 indicating that a second program segment is added after the first program segment. If no, the process goes to step 08.

Step 08: Is the command for deleting an existing program segment? If yes, an appointed program segment is deleted according to the command, and then the process returns to step 02. For example, “ED0300000000EQ” is input, then, the display device shows “ED03”, 03 indicating the third program segment has been deleted. If no, the process goes to step 09.

Step 09: Is the command for modifying an existing program segment? If yes, an appointed program segment stored is modified according to the command, and then the process returns to step 02. For example, “EM0300020003EQ” is input, then, the display device 30 shows “EM03”, indicating that the third program segment has been modified to control the powerbox 10 to be powered off after 2 seconds and then powered on again 3 seconds after that. If no, the process goes to step 10.

step 10: Is the command for running program segments. If yes, the process goes to step 11. If no, the process returns to step 02.

step 11: Running a single program segment or several program segments according to the command. For example, “RS0002000300EQ” is input, then, display device 30 shows “RS00”, indicating that the command is successfully received. The powerbox 10 is controlled to run a loop wherein, the powerbox 10 powers off after 2 seconds and then powers on 3 seconds after that. If “RP0104000500EQ” is input, the display device 30 shows “RP0104”, indicating that the command is successfully received. The powerbox 10 is controlled to run 5 loops according to the first program segment consecutively to the fourth program segment.

step 12: Is there a stop command input? If yes, the program segments stop running, and then the process returns to step 02. If no, the process goes to step 13.

step 13: Has running of the loop command finished? If yes, the process returns to step 02. If no, the process returns to step 12.

All of the above commands are identified and executed by the first storing module 12 to achieve the aforesaid results.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power system, comprising:
a powerbox comprising a first storing module and a second programmable storing module for storing at least one program segment, the program segment being for setting the on/off schedule of the powerbox, the first storing module and the second storing module connected to each other;
an input device connected to the powerbox for input of commands thereto, the first storing module storing a program for identifying and executing the commands and running the program segment in the second storing module according to the commands; and
a display device connected to the powerbox for showing results of executing the commands.

2. The power system as described in claim 1, wherein the first storing module is a single chip.

3. The power system as described in claim 1, wherein the second storing module has a non-volatile memory for ensuring the program segments are maintained in the second storing module even through the powerbox is cut off.

4. A work flow of a power system which comprises a powerbox, an input device, and a display device, for controlling the powerbox to be powered on and off alternately, the work flow comprising:
receiving a command via the input device;
determining type of the command via the powerbox; when the command being a command of inquiring information, displaying corresponding information according to the content of the inquiring command via the display device; when the command being an editing command, editing at least one of program segments stored in the powerbox; when the command being a running command, the powerbox being powered on/off alternately according to the content of the running command.

5. The work flow of claim 4, wherein the step of determining type of the command comprises determining whether the command being a command of inquiring information, if yes, displaying corresponding information according to the content of the inquiring command via the display device, if no, determining whether the command being an editing command, if yes, editing at least one of program segments stored in the powerbox, if no, determining whether the command being a running command, if yes, running at least one program segment stored in the powerbox according to the command to power on/off the powerbox alternately according to content of the program segment.

6. The work flow of claim 5, wherein determining whether the command being an inquiring command comprises determining whether the command being a command for displaying basic information of the powerbox.

7. The work flow of claim 6, wherein the powerbox comprises a programmable storing module for storing the program segments, and the step of determining whether the command being an inquiring command further comprises a step of determining whether the command being a command for displaying information of the programmable storing module.

8. The work flow of claim 7, wherein the step of determining whether the command being an inquiring command further comprises a step of determining whether the command being a command for displaying detailed content of the program segments.

9. The work flow of claim 4, wherein the step of determining whether the command being an editing command comprises a step of determining whether the command being for adding a new program segment, if yes, a specified segment is added after an existing program segment appointed by the command.

10. The work flow of claim 4, wherein the step of determining whether the command being an editing command further comprises a step of determining whether the command being for deleting and/or modifying an existing program segment stored in the powerbox.

11. The work flow of claim 4, wherein when the running command is a single running command, the powerbox is controlled to be powered on and off one loop, and when the running command is for running a plurality of program segments sequentially, the powerbox is controlled to be powered on and off alternately in a loop according to the content of the command.

12. The work flow of claim 4, wherein the work flow further comprises a step of determining whether a stop command being input, if yes, the running step is stopped.

13. The work flow of claim 4, wherein the work flow further comprises a step of determining whether running of the loop command finished, if yes, the running step is stopped.

14. The work flow of claim 4, further comprising showing results on the display device after executing the command.
